(19) United States
(12) Patent Application Publication
(10) Pub. No.: US 2024/0368485 A1
(43) Pub. Date: Nov. 7, 2024

(54) CHEMICAL FACILITY AND PROCESS USING RECYCLED CONTENT OR HYDROGEN-ENRICHED FUEL GAS

(71) Applicant: Eastman Chemical Company, Kingsport, TN (US)

(72) Inventors: Xianchun Wu, Longview, TX (US); Daryl Bitting, Longview, TX (US); David Eugene Slivensky, Tatum, TX (US); Michael Gary Polasek, Longview, TX (US); Avery L. Anderson, Longview, TX (US)

(73) Assignee: Eastman Chemical Company, Kingsport, TN (US)

(21) Appl. No.: 18/691,085

(22) PCT Filed: Sep. 16, 2022
(86) PCT No.: PCT/US2022/043735

§ 371 Date: Mar. 12, 2024

Related U.S. Application Data
(60) Provisional application No. 63/261,422, filed on Sep. 21, 2021.

(51) Int. Cl. C10G 65/12; B01D 53/04; C10B 53/07; C10J 3/62; C10L 3/08

(52) U.S. Cl. CPC C10G 65/12; C10B 53/07; C10J 3/62; C10L 3/08; B01D 53/04; B01D 2256/16; B01D 2256/245; C10G 2300/1003; C10J 2300/0946

(57) ABSTRACT

Processes and facilities for providing recycled content hydrocarbon products (r-products) from the pyrolysis of waste plastic are provided. Processing schemes are described herein that increase energy efficiency and help reduce overall environmental impact while producing valuable final products from chemically recycled waste plastic. Use of recycled content and/or high hydrogen content fuel in one or more process furnaces also reduces global warming potential of the facility by reducing carbon emissions, while also improving energy integration.

### BACKGROUND

Waste plastic pyrolysis plays a part in a variety of chemical recycling technologies. Typically, waste plastic pyrolysis facilities produce recycled content pyrolysis oil (r-pyoil) and recycled content pyrolysis gas (r-pygas) that can be further processed to provide a variety of recycled content chemical products and intermediates, such as recycled content ethylene (r-ethylene), recycled content ethane (r-ethane), recycled content propylene (r-propylene), recycled content propane (r-propane) and others. Unfortunately, under conventional operation, interconnected pyrolysis and product separation facilities can lack energy efficiency, which can be costly from both a financial and environmental standpoint.

However, when pyrolysis facilities are added to an existing downstream facility, such as a cracking facility, the carbon footprint of the resulting combined facilities is typically not optimized, since the primary focus is on the production of specific recycled content products. Consequently, even though recycled content products are being produced by these combined facilities, the environmental impact of the combined facilities may not be thoroughly analyzed to minimize the amount of carbon dioxide released into the environment. Therefore, these combined facilities may exhibit one or more process deficiencies that negatively impact the global warming potential of the combined facilities. Thus, a processing scheme for waste plastic pyrolysis that provides a lower carbon footprint is needed.

For example, natural gas is often used as fuel for process furnaces (e.g., pyrolysis and/or cracker furnaces). In the past, streams such as pyrolysis gas have been used, but this is not as desirable presently since the pyrolysis gas now includes recycled content and can be utilized in forming other, higher value chemical products and intermediates. When external (purchased) natural gas is used, this does not include recycled content and also provides higher levels of carbon emissions in the form of carbon dioxide (CO2) and carbon monoxide (CO), which increases the carbon footprint and GWP of the facility or facilities. Thus, a processing scheme is needed that maximizes use of the recycled content from waste plastic while also minimizing carbon emissions, particularly in an integrated facility.

### SUMMARY

In one aspect, the present technology concerns a chemical recycling process, said process comprising: (a) pyrolyzing a waste plastic feed in a pyrolysis facility to provide a recycled content pyrolysis effluent (r-pyrolysis effluent), wherein the pyrolyzing includes combusting a first fuel gas in a pyrolysis furnace; (b) cracking a hydrocarbon feed in a cracker furnace of a cracking facility to provide a cracker furnace effluent, wherein the cracking includes combusting a second fuel gas in the cracker furnace; and (c) separating a recycled content cracked stream (r-cracked stream) in a separation zone of the cracking facility to provide at least one recycled content product (r-product), wherein the r-cracked stream comprises at least a portion of the cracker furnace effluent, wherein at least one of the following criteria (i) through (vi) are met—(i) the first fuel gas has a hydrogen content of at least 10 mole percent; (ii) the second fuel gas has a hydrogen content greater than 40 mole percent; (iii) the first fuel gas comprises hydrogen originating from the cracking facility; (iv) at least one of the first and second fuel gas comprises hydrogen originating from the pyrolysis facility; (v) at least one of the first and second fuel gas comprises recycled content hydrogen (r-H2); (vi) wherein the hydrocarbon feed into the cracker furnace comprises at least a portion of the r-pyrolysis effluent and the first fuel gas comprises hydrogen and/or methane originating from the separation zone of the cracking facility; and (vii) wherein the r-cracked stream separated in step (c) comprises at least a portion of the r-pyrolysis effluent and the first fuel gas comprises hydrogen and/or methane originating from the separation zone of the cracking facility.

In one aspect, the present technology concerns a chemical recycling process, said process comprising: (a) compressing a cracker effluent to a pressure of at least 200 pounds per square inch gauge (psig), wherein the cracker effluent comprises a recycled content cracker effluent (r-cracker effluent); (b) separating at least a portion of the compressed r-cracker effluent in a separation zone to thereby produce recycled content methane (r-methane) and/or recycled content hydrogen (r-H2); and (c) combusting fuel to furnish thermal energy to a pyrolysis reactor and/or a cracking furnace in at least one process furnace in a pyrolysis and/or a cracking facility to heat at least one process stream, wherein the fuel comprises at least a portion of the r-methane and/or the r-H2.

In one aspect, the present technology concerns a chemical recycling process, said process comprising: (a) separating recycled content syngas (r-syngas) in a separation zone to thereby produce recycled content hydrogen (r-H2); and (b) combusting fuel to furnish thermal energy to a pyrolysis reactor and/or a cracking furnace in at least one process furnace in a pyrolysis and/or a cracking facility to heat at least one process stream, wherein the fuel comprises recycled content from the r-H2.

In one aspect, the present technology concerns a chemical recycling process, said process comprising: (a) pyrolyzing a stream comprising waste plastic to provide a recycled content pyrolysis effluent (r-pyrolysis effluent); (b) introducing at least a portion of the r-pyrolysis effluent into a cracking facility; (c) recovering an overhead stream from the cracking facility; (d) optionally subjecting a hydrocarbon feed to a molecular reformer to provide a synthesis gas; and (e) using at least a portion of the overhead stream and/or syngas as a fuel to provide heat for the pyrolyzing of step (a).

### BRIEF DESCRIPTION OF THE DRAWINGS

FIG. 1 is a block flow diagram illustrating the main steps of a process and facility for pyrolyzing waste plastic and introducing at least a portion of the r-pyrolysis vapor and/or r-pyrolysis oil into a cracking facility, particularly illustrating possible streams from the cracking facility that can be used as fuel in the pyrolysis and/or cracker furnace;

FIG. 2A is a block flow diagram illustrating the main steps of a portion the cracking facility, particularly illustrating an embodiment where the hydrogen separation step is first in the separation zone;

FIG. 2B is a block flow diagram illustrating the main steps of a portion the cracking facility, particularly illustrating an embodiment where the cold box is first in the separation zone;

FIG. 2C is a block flow diagram illustrating the main steps of a portion the cracking facility, particularly illustrating an embodiment where the deethanizer column is first in the separation zone;

FIG. 2D is a block flow diagram illustrating the main steps of a portion the cracking facility, particularly illustrating an embodiment where the depropanizer column is first in the separation zone; and

FIG. 3 is a block flow diagram of the main steps of a process and facility for pyrolyzing waste plastic and cracking hydrocarbon-containing feed similar to that shown in FIG. 1, but also including a molecular reforming step/facility.

### DETAILED DESCRIPTION

To optimize the carbon footprint of the recycling facility described herein, we have discovered that one or more C1 and lighter streams (e.g., methane and/or hydrogen) recovered from the pyrolysis and/or cracking facilities may be used as a source of fuel for the pyrolysis and/or cracker facility. More particularly, we have found that integrating the pyrolysis facility and the cracking facility by utilizing these streams as fuel reduces carbon footprint and global warming potential of the combined facilities, while also providing valuable recycled content chemical intermediate and final products.

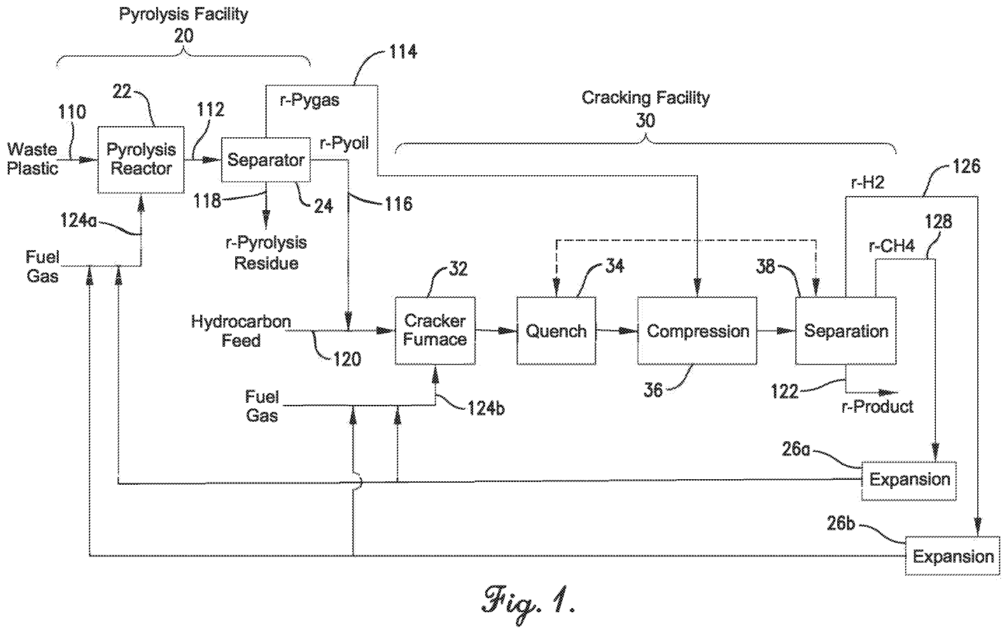

Turning first to FIG. 1, a process and system for use in chemical recycling of waste plastic is provided. The process/facility shown in FIG. 1 includes a pyrolysis facility 20 and a cracking facility 30. The pyrolysis facility 20 pyrolyzes a stream of waste plastic 110 to provide recycled content products, at least a portion of which can be introduced into the cracking facility to provide at least one recycled content product (r-product) 122. As also shown in FIG. 1, at least one recycled content overhead stream (r-overhead stream), shown in FIG. 1 as a recycled content methane (r-methane or r-CH4) and/or recycled content hydrogen (r-H2) stream, from the cracking facility 30 can be utilized as fuel gas to provide thermal energy to the cracker furnace 32 and/or pyrolysis unit 22. While the r-methane and/or r-H2 have previously used in other processes or to form other products, we have found that using at least a portion of one or both as fuel to provide energy to one or both facilities lowers the carbon footprint and global warming potential (GWP) of the combined facility.

In some embodiments, the pyrolysis facility 20 and cracking facility 30 may be co-located. As used herein, the term “co-located” refers to the characteristic of at least two objects being situated on a common physical site, and/or within 1, within 0.75, within 0.5, or within 0.25 miles of each other, measured as a straight-line distance between two designated points. In some embodiments, the pyrolysis facility 20 and cracking facility 30 may be located remotely from one another. As used herein, the term “located remotely” refers to a distance of greater than 1, greater than 5, greater than 10, greater than 50, greater than 100, greater than 500, greater than 1000, or greater than 10,000 miles between two facilities, sites, or reactors.

When two or more facilities are co-located, the facilities may be integrated in one or more ways. Examples of integration include, but are not limited to, heat integration, utility integration, waste-water integration, mass flow integration via conduits, office space, cafeterias, integration of plant management, IT department, maintenance department, and sharing of common equipment and parts, such as seals, gaskets, and the like.

In some embodiments, the pyrolysis facility/process 20 is a commercial scale facility/process receiving the waste plastic feedstock 110 at an average annual feed rate of at least 100, or at least 500, or at least 1,000, at least 2,000, at least 5,000, at least 10,000, at least 50,000, or at least 100,000 pounds per hour, averaged over one year. Further, the pyrolysis facility 20 can produce the one or more recycled content product streams at an average annual rate of at least 100, or at least 1,000, or at least 5,000, at least 10,000, at least 50,000, or at least 75,000 pounds per hour, averaged over one year. When more than one r-product stream is produced, these rates can apply to the combined rate of all r-products.

Similarly, the cracking facility/process 30 can be a commercial scale facility/process receiving hydrocarbon feed 120 at an average annual feed rate of at least at least 100, or at least 500, or at least 1,000, at least 2,000, at least 5,000, at least 10,000, at least 50,000, or at least 75,000 pounds per hour, averaged over one year. Further, the cracking facility 30 can produce at least one recycled content product stream 122 at an average annual rate of at least 100, or at least 1,000, or at least 5,000, at least 10,000, at least 50,000, or at least 75,000 pounds per hour, averaged over one year. When more than one r-product stream is produced, these rates can apply to the combined rate of all r-products.

As shown in FIG. 1, the process starts with a pyrolysis step 20 where waste plastic 110 is pyrolyzed in a pyrolysis reactor of pyrolysis unit 22. The pyrolysis unit 22 can include a pyrolysis reactor as well as any additional equipment (e.g., process furnaces, heat exchangers, etc.) needed for the reactor to process waste plastic. In some cases, the pyrolysis unit 22 can include a pyrolysis furnace that is used as a reactor, while in other cases, the pyrolysis unit 22 can include a furnace for heating a heat transfer medium, which is then used to provide thermal energy to the pyrolysis reactor. The pyrolysis reaction involves chemical and thermal decomposition of sorted waste plastic introduced into the reactor. Although all pyrolysis processes may be generally characterized by a reaction environment that is substantially free of oxygen, pyrolysis processes may be further defined by other parameters such as the pyrolysis reaction temperature within the reactor, the residence time in the pyrolysis reactor, the reactor type, the pressure within the pyrolysis reactor, and the presence or absence of pyrolysis catalysts.

The pyrolysis reaction can involve heating and converting the waste plastic feedstock in an atmosphere that is substantially free of oxygen or in an atmosphere that contains less oxygen relative to ambient air. For example, the atmosphere within the pyrolysis reactor may comprise not more than 5, not more than 4, not more than 3, not more than 2, not more than 1, or not more than 0.5 weight percent of oxygen.

The temperature in the pyrolysis reactor can be adjusted to facilitate the production of certain end products. In some embodiments, the peak pyrolysis temperature in the pyrolysis reactor can be at least 325° C., or at least 350° C., or at least 375° C., or at least 400° C. Additionally or alternatively, the peak pyrolysis temperature in the pyrolysis reactor can be not more than 800° C., not more than 700° C., or not more than 650° C., or not more than 600° C., or not more than 550° C., or not more than 525° C., or not more than 500° C., or not more than 475° C., or not more than 450° C., or not more than 425° C., or not more than 400° C. More particularly, the peak pyrolysis temperature in the pyrolysis reactor can range from 325 to 800° C., or 350 to 600° C., or 375 to 500° C., or 390 to 450° C., or 400 to 500° C.

The residence time of the feedstock within the pyrolysis reactor can be at least 1, or at least 5, or at least 10, or at least 20, or at least 30, or at least 60, or at least 180 seconds. Additionally, or alternatively, the residence time of the feedstock within the pyrolysis reactor can be less than 2, or less than 1, or less than 0.5, or less than 0.25, or less than 0.1 hours. More particularly, the residence time of the feedstock within the pyrolysis reactor can range from 1 second to 1 hour, or 10 seconds to 30 minutes, or 30 seconds to 10 minutes.

The pyrolysis reactor can be maintained at a pressure of at least 0.1, or at least 0.2, or at least 0.3 barg and/or not more than 60, or not more than 50, or not more than 40, or not more than 30, or not more than 20, or not more than 10, or not more than 8, or not more than 5, or not more than 2, or not more than 1.5, or not more than 1.1 barg. The pressure within the pyrolysis reactor can be maintained at atmospheric pressure or within the range of 0.1 to 60, or 0.2 to 10, or 0.3 to 1.5 barg.

The pyrolysis reaction in the reactor can be thermal pyrolysis, which is carried out in the absence of a catalyst, or catalytic pyrolysis, which is carried out in the presence of a catalyst. When a catalyst is used, the catalyst can be homogenous or heterogeneous and may include, for example, certain types of zeolites and other mesostructured catalysts.

As shown in FIG. 1, a pyrolysis effluent stream 112 removed from the pyrolysis unit 22 can be separated in at least one separator, shown as separator 24 in FIG. 1, to produce a recycled content pyrolysis gas (r-pygas) 114, a recycled content pyrolysis oil (r-pyoil) 116, and a recycled content pyrolysis residue (r-pyrolysis residue) 118. As used herein, the term “r-pyrolysis effluent” refers to the outlet stream withdrawn from the pyrolysis reactor. The r-pyrolysis effluent includes r-pygas, r-pyoil, and r-pyrolysis residue.

As used herein, the term “r-pyrolysis residue” refers to a composition obtained from waste plastic pyrolysis that comprises predominantly pyrolysis char and pyrolysis heavy waxes. As used herein, the term “pyrolysis char” refers to a carbon-containing composition obtained from pyrolysis that is solid at 200° C. and 1 atm. As used herein, the term “pyrolysis heavy waxes” refers to C20+ hydrocarbons obtained from pyrolysis that are not pyrolysis char, pyrolysis gas, or pyrolysis oil. As used herein, the term “r-pygas” refers to a composition obtained from waste plastic pyrolysis that is gaseous at 25° C. at 1 atm. As used herein, the terms “r-pyoil” refers to a composition obtained from waste plastic pyrolysis that is liquid at 25° C. and 1 atm.

In some embodiments, the r-pygas 114 can include C2 and/or C3 components each in an amount of 5 to 60, 10 to 50, or 15 to 45 weight percent, C4 components in an amount of 1 to 60, 5 to 50, or 10 to 45 weight percent, and C5 components in an amount of 1 to 25, 3 to 20, or 5 to 15 weight percent.

In some embodiments, the r-pyoil 116 can include at least 50, at least 75, at least 90, or at least 95 weight percent of C4 to C30, C5 to C25, C5 to C22, or C5 to C20 hydrocarbon components. The r-pyoil 116 can have a 90% boiling point in the range of from 150 to 350° C., 200 to 295° C., 225 to 290° C., or 230 to 275° C. As used herein, “boiling point” refers to the boiling point of a composition as determined by ASTM D2887-13. Additionally, as used herein, an “90% boiling point,” refers to a boiling point at which 90 percent by weight of the composition boils per ASTM D-2887-13.

In some embodiments, the r-pyoil 116 can comprise heteroatom-containing compounds in an amount of less than 20, less than 10, less than 5, less than 2, less than 1, or less than 0.5 weight percent. As used herein, the term “heteroatom-containing” compound includes any compound or polymer containing nitrogen, sulfur, or phosphorus. Any other atom is not regarded as a “heteroatom” for purposes of determining the quantity of heteroatoms, heterocompounds, or heteropolymers present in the r-pyoil 116. Heteroatom-containing compounds include oxygenated compounds. Often, such compounds exist in the r-pyoil 116 when the pyrolyzed waste plastic includes polyethylene terephthalate (PET) and/or polyvinyl chloride (PVC). Thus, little to no PET and/or PVC in the waste plastic 110 results in little to no heteroatom-containing compounds in the r-pyoil 116.

As shown in FIG. 1, at least a portion of the r-pygas 114 can be introduced into a cracking facility 30. In some embodiments, at least 50, at least 75, at least 90, or at least 95 percent of the r-pygas 114 from the pyrolysis facility 20 can be introduced into the cracking facility 30. In some cases, all or a portion of the r-pygas 114 may be introduced into at least one location upstream of the cracker furnace 32. Additionally, or alternatively, all or a portion of the r-pygas 114 may be introduced into at least one location downstream of the cracker furnace 32.

When introduced into a location downstream of the cracker furnace 32, the r-pygas 114 may be introduced into one or more of the following locations: (i) the quench zone 34, which cools and partially condenses the furnace effluent; (ii) the compression zone 36, which compresses the vapor portion of the furnace effluent in two or more compression stages; and (iii) the separation zone 38, which separates the compressed stream into two or more recycled content products 122 (r-products). In some cases, the r-pygas 114 may be introduced into only one of these locations, while, in other cases, the r-pygas 114 may be divided into additional fractions and each fraction introduced into a different location. In such cases, the fractions of the r-pygas 114 may be introduced into at least two, three, or all of the locations shown in FIG. 1.

As shown in FIG. 1, in some embodiments, at least a portion of the r-pyoil 116 can be introduced into the inlet of the cracker furnace 32. When introduced into the cracker furnace 32, the r-pyoil 116 may be combined with the hydrocarbon feed 120 introduced into the inlet of cracker furnace 32. The hydrocarbon feed 120 may comprise predominantly C3 to C5 hydrocarbon components, C5 to C22 hydrocarbon components, or C3 to C22 hydrocarbon components, or even predominantly C2 components. As used herein, the term “predominantly” means at least 50 weight percent. The hydrocarbon feed 120 may include recycled content from one or more sources, or it may include non-recycled content. Additionally, in some cases, the hydrocarbon feed 120 may not include any recycled content. The hydrocarbon feed 120 may also include r-pyoil from another pyrolysis facility (not shown in FIG. 1).

As shown in FIG. 1, the hydrocarbon feed 120 (optionally combined with the r-pyoil 116) may be introduced into the cracker furnace 32, wherein it can be thermally cracked to form a lighter hydrocarbon-containing furnace effluent. The furnace effluent stream from the cracker furnace 32 can then be cooled in the quench zone 34 and compressed in the compression zone 36. The compressed stream from the compression zone 36 can be further separated in the separation zone 38 to produce at least one recycled content product (r-product) 122. Examples of recycled content products include, but are not limited to, recycled content ethane (r-ethane), recycled content ethylene (r-ethylene), recycled content propane (r-propane), recycled content propylene (r-propylene), recycled content butane (r-butane), recycled content butenes (r-butenes), recycled content butadiene (r-butadiene), and recycled content pentanes and heavier (r-C5+). In some embodiments, at least a portion of the recycled content stream (e.g., r-ethane or r-propane) may be returned to the inlet of the cracker furnace 32 as a reaction recycle stream (not shown in FIG. 1).

In some embodiments, at least a portion of a recycled content stream from the cracking facility 30 and/or at least a portion of a recycled content stream from the pyrolysis facility 20 can be used as fuel to provide thermal energy to the pyrolysis reactor and/or the cracker furnace 32. Such a stream can be a lighter or vapor-phase stream (e.g., predominantly methane and/or hydrogen) and may be withdrawn from one or more process units as an overhead stream. When such a recycled content overhead stream (r-overhead stream) is used in a process furnace, the carbon footprint of the facility can be improved, since less non-recycled content natural gas is required to operate the facility. Additionally, use of high hydrogen content fuel gas lowers the carbon-based emissions in the form of carbon dioxide (CO2) and carbon monoxide (CO). This improves the GWP of the facility.

In some cases, the r-overhead stream used to furnish thermal energy to the pyrolysis reactor and/or cracker furnace 32 can originate from the separation zone 38 of the cracking facility. The thermal energy can be furnished directly or indirectly. For example, in some embodiments, the pyrolysis reactor can be a furnace and all or a portion of the r-overhead stream can be directly combusted in the furnace. In other embodiments, all or a portion of the r-overhead stream can be combusted in another process furnace used to heat a stream of heat transfer medium which can then be used to provide thermal energy to the pyrolysis reactor (e.g., in a reactor jacket or heat exchanger).

In some embodiments, at least one r-overhead stream can be recovered from the separation zone 38 and combined with the fuel gas 124a used to provide thermal energy to the pyrolysis reactor and/or the fuel gas 124b used to provide thermal energy to the cracker furnace 32. The r-overhead stream can comprise predominantly methane, predominantly hydrogen, or may include a combination of methane and hydrogen. At least a portion of the methane can be recycled content methane (r-methane) and/or at least a portion of the hydrogen can be recycled content hydrogen (r-H2). In the embodiment shown in FIG. 1, the r-overhead stream can include the r-H2 stream 126 and/or the r-methane (r-CH4) stream 128.

In some embodiments, the r-overhead stream can comprise at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, or at least 95 mole percent hydrogen and/or not more than 95, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, or not more than 10 mole percent hydrogen. The r-overhead stream can include not more than 20, not more than 15, not more than 10, not more than 5, not more than 2, not more than 1, or not more than 0.5 mole percent of compounds other than hydrogen.

In some embodiments, the r-overhead stream can comprise at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, or at least 95 mole percent methane and/or not more than 95, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, or not more than 10 mole percent methane. The r-overhead stream can include not more than 20, not more than 15, not more than 10, not more than 5, not more than 2, not more than 1, or not more than 0.5 mole percent of compounds other than methane.

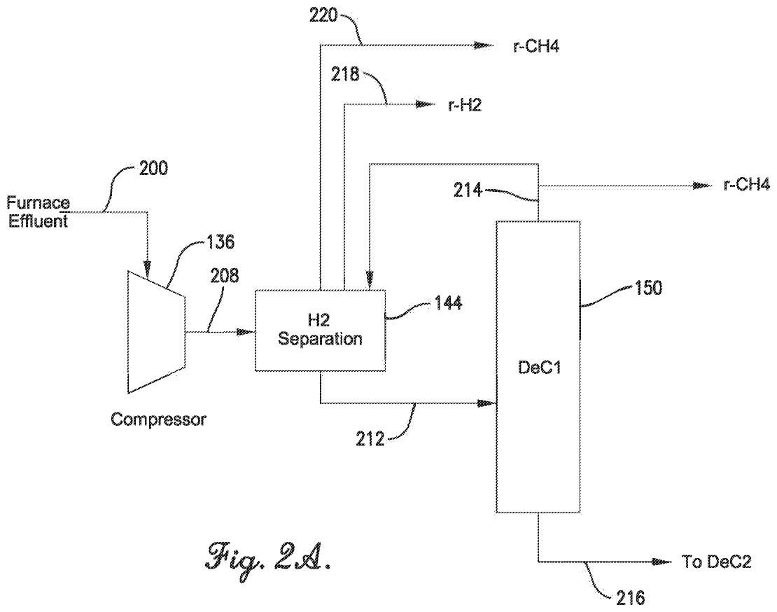

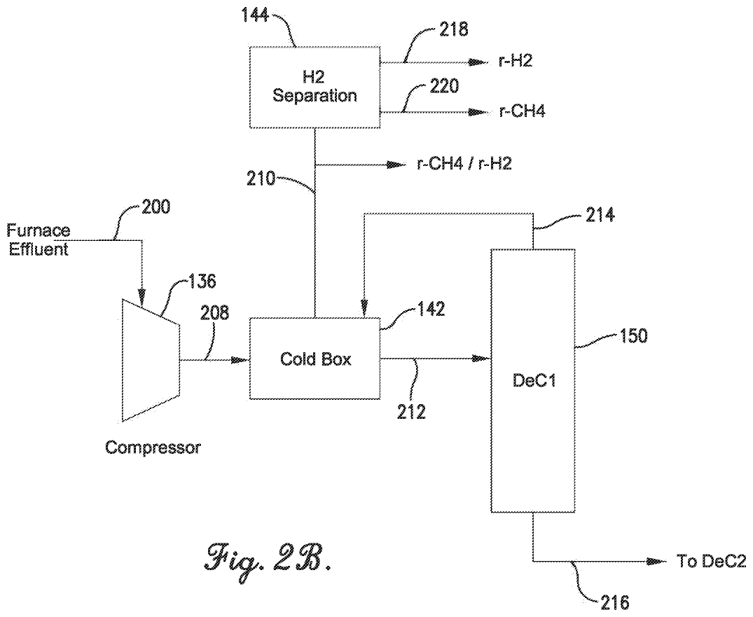

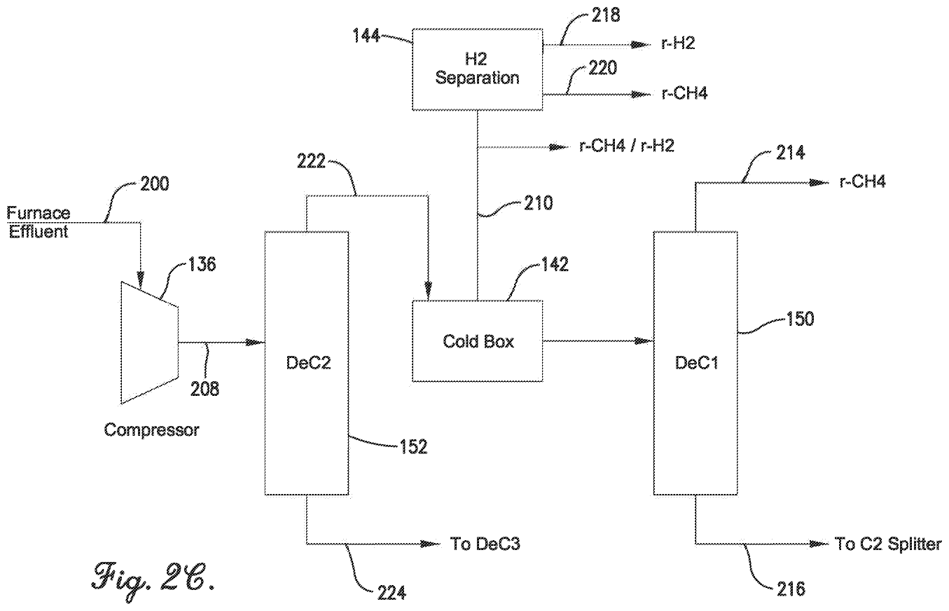

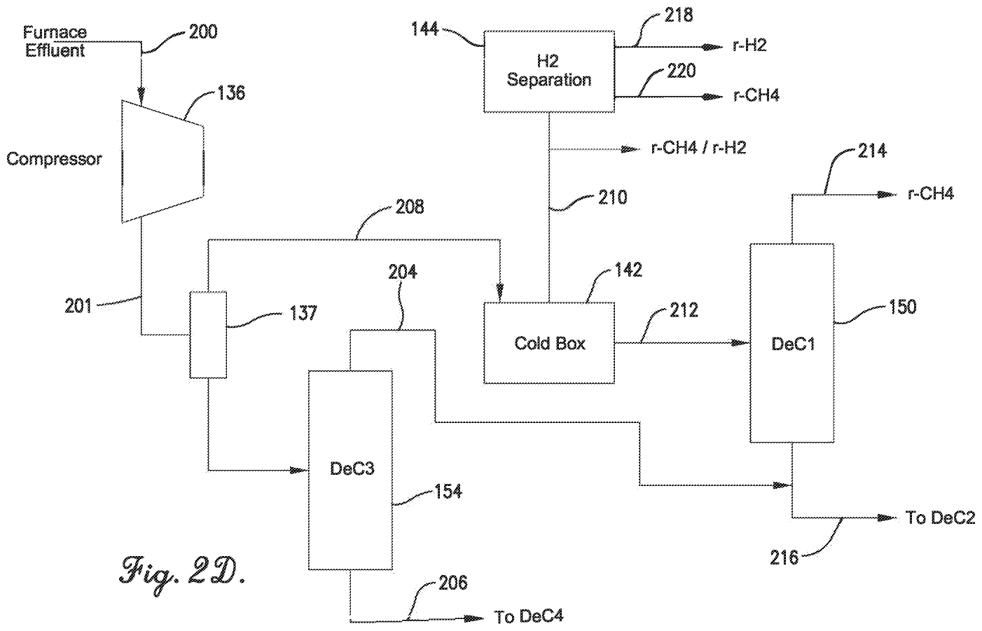

The r-overhead stream withdrawn from the cracking facility 30 may comprise one or more of an overhead stream withdrawn from a demethanizer, a stream recovered from a cold box, and a stream withdrawn from a hydrogen separation unit. One or more r-overhead streams may be withdrawn from a single separation zone 38, or a single r-overhead stream may be formed by combining two or more streams from these locations. Although generally shown in FIG. 1 as including a recycled content hydrogen (r-H2) stream 126 and a recycled content methane stream (r-methane or r-CH4), it should be understood that the r-overhead stream recovered from the separation zone 38 of the cracking facility can include only one of these streams 126, 128 or it can include both as either single streams (as shown in FIG. 1) or in a combined stream (not shown) comprising both r-methane and r-H2. Several embodiments of specific configurations for recovering various types of r-overhead streams are illustrated in FIGS. 2A-D.

Turning first to FIG. 2A, one embodiment wherein the r-overhead stream comprises an overhead stream withdrawn from a hydrogen separation unit is shown. As shown in FIG. 2A, the furnace effluent stream 200 exiting the quench zone of the cracking facility (not shown) can be compressed in a compressor 136 and the resulting compressed stream 208 may be introduced into the hydrogen separation zone 144. The pressure of the compressed stream 208 can be at least 200, at least 250, at least 300, at least 350, at least 400, or at least 450 pounds per square inch gauge (psig) and/or not more than 1000, not more than 900, not more than 800, not more than 700, or not more than 600 psig.

The compressed stream 208 can include at least 50, at least 75, at least 90, at least 95, at least 97, or at least 99 mole percent of methane and/or at least 50, at least 75, at least 90, or at least 95 mole percent of hydrogen. The total amount of methane and hydrogen combined in the compressed stream 208 can be at least 75, at least 80, at least 85, at least 90, at least 95, at least 97, or at least 99 mole percent. The methane can comprise recycled content methane (r-methane) and/or the hydrogen can comprise recycled content hydrogen (r-hydrogen).

Hydrogen separation zone 144 can comprise any suitable process and apparatus for removing hydrogen from the incoming feed stream. Examples of suitable processes/apparatuses include, but are not limited to, catalytic purification, metal hydride separation, pressure swing absorption, cryogenic distillation and/or membrane separation, including noble metal membrane separation, polymer membrane separation, or electrochemical membrane separation.

As shown in FIG. 2A, an overhead stream comprising predominantly recycled content methane (r-methane or r-CH4) 220 and an overhead stream comprising predominantly recycled content hydrogen (r-H2) 218 can be withdrawn from the hydrogen separation zone 144. The heavier stream 212 from the hydrogen separation zone 144 may be introduced into a demethanizer 150, where it can be separated into a demethanizer overhead stream 214 and a demethanizer bottoms stream 216. At least a portion of the demethanizer overhead stream 214, which can include predominantly methane and lighter components, may be reintroduced into the hydrogen separation zone 144, while the demethanizer bottoms stream 216, which can include predominantly ethylene and heavier components, can be passed to a deethanizer column (not shown). In some cases, at least a portion of the demethanizer overhead stream 214 can be withdrawn from the separation zone as a stream of recycled methane (r-CH4), as shown in FIG. 2A. Referring now to FIG. 2B, another embodiment wherein the r-overhead stream originates from a hydrogen separation zone 144 is shown. In this embodiment, the compressed effluent stream 208 from the compressor 136 is first introduced into a cold box 142, where the stream is cooled and at least partially condensed in one or more heat exchangers (not shown). In a cold box, the heat exchangers (as well as any interim vapor-liquid separation vessels) are contained in an enclosed, heat-insulated zone in order to minimize heat loss to the environment. The resulting overhead stream 210 (e.g., predominantly vapor phase stream) from the cold box 142 comprises r-methane and r-hydrogen in a combined amount of at least 25, at least 35, at least 50, at least 55, at least 65, at least 75, at least 85, or at least 90 mole percent and/or not more than 99, not more than 95, not more than 90, not more than 85, or not more than 80 mole percent. As shown in FIG. 2B, the r-overhead stream withdrawn from the separation zone (and subsequently used as fuel as described herein) can include all or a part of the cold box overhead stream 210.

Alternatively, or in addition, at least a portion of the cold box overhead stream 210 can be introduced into a hydrogen separation unit 144 as described in detail with respect to FIG. 2A. The resulting r-methane stream 220 and/or r-H2 stream 218 withdrawn from the hydrogen separation unit 144 can be used as or as part of the r-overhead stream withdrawn from the separation zone 38.

Turning now to FIG. 2C, another embodiment wherein the r-overhead stream originates from a cold box 142 is provided. As shown in FIG. 2C, the compressed effluent 208 from the compressor 136 is introduced into a deethanizer column 152, where the stream is separated into a lighter deethanizer overhead stream 222 and a heavier deethanizer bottoms stream 224. The deethanizer bottoms stream 224, which can comprise predominantly propylene and lighter components, can be routed to a depropanizer column (not shown), while the deethanizer overhead stream 222 can be introduced into a cold box 142. The remainder of the system shown in FIG. 2C can be operated in a similar manner as described previously with respect to FIG. 2B.

Turning now to FIG. 2D, yet another embodiment wherein the r-overhead stream originates from a cold box 142 is provided. In the embodiment shown in FIG. 2D, the furnace effluent 200 withdrawn from the quench zone (not shown) is compressed in one or more stages of a compressor 136, and at least a portion of the interstage liquid 202 can be removed and introduced into a depropanizer column 154. The depropanizer bottoms stream 206 can be routed to a debutanizer (not shown), while the depropanizer overhead stream 204 can be reintroduced into a later stage of the compressor 136. The compressed effluent stream 208 from the last stage of the compressor 136 can then be introduced into the cold box 142 and can proceed through the system as described previously with respect to FIGS. 2B and 2C.

Referring again to FIG. 1, at least a portion of the r-overhead stream (generally shown as the r-H2 stream 126 and/or r-methane stream 128) withdrawn from the separation zone 38 of the cracking facility 30 can combined with the pyrolysis fuel 124a and/or the cracker fuel 124b and combusted in the pyrolysis facility 20 (in the pyrolysis furnace, when present, or in another process furnace) and/or the cracker furnace 32. In some embodiments, at least a portion of the r-H2 stream 126 can be combined with the cracker fuel 124b, with the pyrolysis fuel 124a, or both the cracker fuel 124b and the pyrolysis fuel 124a. Similarly, at least a portion of the r-methane stream 128 can be combined with the cracker fuel 124b, the pyrolysis fuel 124a, or both the cracker fuel 124b and the pyrolysis fuel 124a.

In some embodiments, as shown in FIG. 1, at least a portion of the r-overhead stream (e.g., r-H2 stream 126 and/or r-methane stream 128) can be expanded in an expansion zone (shown as zones 26a and 26b in FIG. 1) prior to the expanded stream being utilized as fuel in one or more process furnaces. When all or a portion of the r-overhead stream (or the r-H2 stream 126 and/or r-methane stream 128) are expanded, at least a portion of the work can be recovered and used in another portion of the pyrolysis facility 20 and/or cracking facility 30. Any suitable device or combination of devices can be used to perform the expansion step including, but not limited to, expansion valves, turboexpanders, and combinations thereof.

The r-overhead stream (or r-H2 stream 126 and/or r-methane stream 128) used as fuel to provide thermal energy to the pyrolysis reactor and/or cracker furnace 32 can be combined with an outside fuel source without recycled content. In such cases, the combined fuel streams 124a,b can have a total recycled content of at least 10, at least 20, at least 30, at least 40, at least 50, at least 60, at least 70, at least 80, at least 90, or at least 95 percent. One or both of the pyrolysis fuel 124a and the cracker fuel 124b can comprise non-recycled content such as, for example, non-recycled content natural gas. However, such components are present in a far lower amount, if at all, as compared to conventional facilities. As discussed previously, this helps reduce the carbon footprint of one or both facilities.

In some embodiments, the pyrolysis fuel 124a and/or cracker fuel 124b can have a hydrogen content of at least 10, at least 15, at least 20, at least 25, at least 30, at least 35, at least 40, at least 45, at least 50, at least 55, at least 60, at least 65, at least 70, at least 75, at least 80, at least 85, at least 90, or at least 95 mole percent. The hydrogen can comprise recycled content hydrogen (r-H2) and/or non-recycled content hydrogen. All or a portion of the hydrogen in the pyrolysis fuel 124a and/or cracker fuel 124b can originate from the pyrolysis facility 20 and/or cracking facility 30. The pyrolysis fuel 124a and/or cracker fuel 124b can comprise less than 15, less than 10, less than 5, less than 2, less than 1, less than 0.5, less than 0.25, or less than 0.1 mole percent of components other than hydrogen (or r-H2).

In some embodiments, the pyrolysis fuel 124a and/or cracker fuel 124b can have a methane content of at least 20, at least 25, at least 30, at least 35, at least 40, at least 45, at least 50, at least 55, at least 60, at least 65, at least 70, at least 75, at least 80, at least 85, at least 90, at least 95, at least 97, at least 99, or at least 99.5 mole percent. The methane can comprise recycled content methane (r-methane) and/or non-recycled content methane. All or a portion of the methane in the pyrolysis fuel 124a and/or cracker fuel 124b can originate from the pyrolysis facility 20 and/or cracking facility 30. The pyrolysis fuel 124a and/or cracker fuel 124b can comprise less than 15, less than 10, less than 5, less than 2, less than 1, less than 0.5, less than 0.25, or less than 0.1 mole percent of components other than methane (or r-methane).

The high heating value (HHV) of the pyrolysis fuel 124a and/or the cracker fuel 124b can be at least 320, at least 350, at least 400, at least 450, at least 500 BTU per standard cubic foot BTU/SCF and/or not more than 1000, not more than 900, not more than 800, or not more than 750 BTU/SCF.

In some embodiments, the pyrolysis fuel 124a and/or the cracker fuel 124b can include both methane and hydrogen, which can include r-methane and/or r-hydrogen. In such cases, the pyrolysis fuel 124a and/or the cracker fuel 124b can have a combined methane and hydrogen content of at least 20, at least 30, at least 40, at least 50, at least 60, at least 70, at least 80, at least 90, or at least 95 mole percent. At least one, or both, of the r-methane and r-H2 in one or both of the fuel streams 124a,b can originate from the cracking facility 30 and/or from the pyrolysis facility 20.

Once the pyrolysis fuel 124a is combusted to provide thermal energy to the pyrolysis reactor 22, a flue gas 138a is removed from the furnace (e.g., the pyrolysis furnace or another process furnace in the pyrolysis facility). Similarly, once the cracking fuel 124b is combusted in the cracker furnace 32, a cracker flue gas 138b is removed from the furnace 32. When the pyrolysis fuel gas 124a and/or cracker fuel gas 124b have higher hydrogen contents (e.g., greater than 10 mole percent in the pyrolysis fuel gas 124b and greater than 40 mole percent in the cracker fuel gas 124b), the flue gases 138a,b from the furnaces have a lower carbon content. For example, in some embodiments, the pyrolysis fuel gas 124a and cracker fuel gas 124b can have a total carbon content of less than 40, less than 35, less than 30, less than 25, less than 20, less than 15, less than 10, or less than 5 mole percent, calculated on a molecular carbon basis. As a result, the pyrolysis flue gas 138a and/or cracker flue gas 138b can comprise a total amount of carbon dioxide (CO2) and carbon monoxide (CO) of less than 8, less than 7, less than 6, less than 5, less than 4, less than 3, less than 2, less than 1, less than 0.5, or less than 0.1 mole percent.

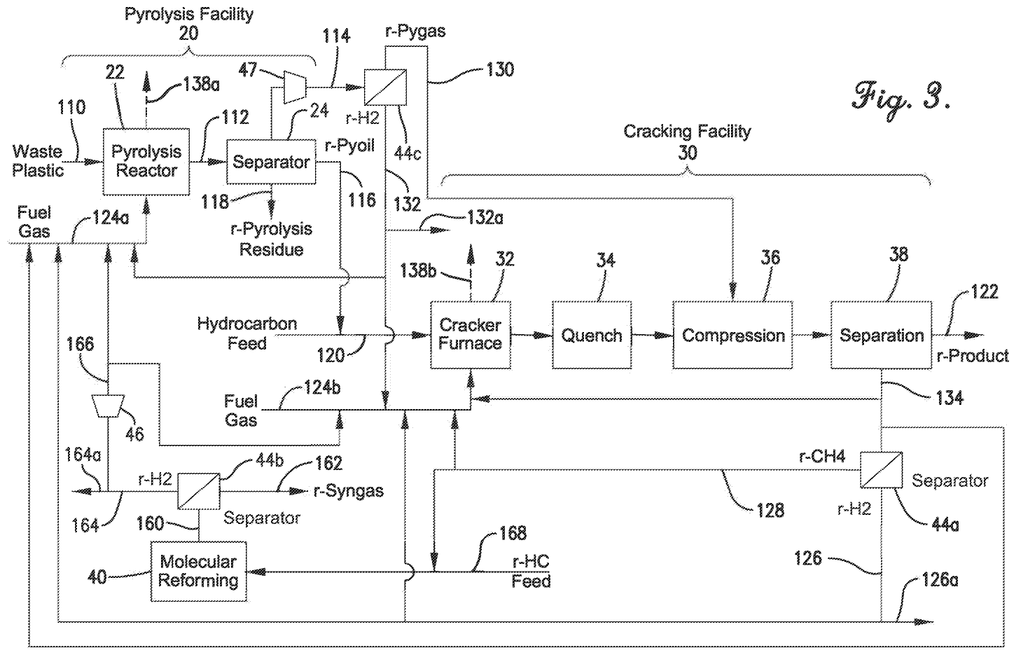

Turning now to FIG. 3, a chemical recycling process/facility similar to the process/facility shown in FIG. 1 is illustrated. In addition to the steps/facilities as described with respect to FIG. 1, the process/system shown in FIG. 3 further includes a molecular reforming facility/step 40. As used herein, the term “molecular reforming” refers to conversion of a carbon-containing feed into syngas (CO, CO2, and H2). Molecular reforming encompasses both steam reforming and partial oxidation (POX) gasification. As used herein, the term “steam reforming” refers to the conversion of a carbon-containing feed into syngas via reaction with water. The steam reforming can be steam methane reforming and the carbon-containing feed can be a methane-containing stream, such as natural gas. As used herein, the term “partial oxidation (POX) gasification” or “POX gasification” refers to high temperature conversion of a carbon-containing feed into syngas, (carbon monoxide, hydrogen, and carbon dioxide), where the conversion is carried out in the presence of a less than stoichiometric amount of oxygen. The carbon containing-feed to POX gasification can include solids, liquids, and/or gases.

As shown in FIG. 3, a recycled content hydrocarbon feed (r-HC feed) 168 can be introduced into the molecular reforming step/facility. The r-HC feed 168 can comprise a solid, a liquid, and/or a gas phase feed. Examples of suitable types of feed include methane, natural gas, naphtha, and coal (or coal slurry). The r-HC feed 168 may include waste plastic or a stream (e.g., naphtha or methane) including recycled content derived from waste plastic. In some cases, the r-HC feed 168 may also include non-recycled content. When the r-HC feed 168 includes recycled content, the resulting syngas 160 formed in the molecular reforming facility 40 comprises recycled content syngas (r-syngas).

According to some embodiments, at least a portion of r-HC feed 168 may originate from the cracking facility 30. More specifically, as shown in FIG. 3, an r-overhead stream 134 withdrawn from the separation zone 38 of the cracking facility 30 may be introduced into a separator 44, which can separate the stream into a predominantly recycled content hydrogen (r-H2) stream 128 and a predominantly recycled methane (r-methane or r-CH4) stream 126. Separator 44a can be any suitable type of separation device discussed herein and can be configured in a manner similar to any of the steps/zones illustrated in FIGS. 2A-D. As illustrated in FIG. 3, at least a portion of the r-methane stream 128 may be introduced into the molecular reforming facility 40, alone or in combination with another hydrocarbon-containing feed with or without recycled content. The resulting syngas 160 can include at least 50, at least 75, at least 90, or at least 95 mole percent hydrogen, including recycled content hydrogen (r-H2).

In some embodiments, at least a portion of the syngas 160 can be passed through a separator 44b, which can separate out a stream of purified recycled content hydrogen (r-H2) 164 from the syngas 162. Examples of suitable processes/apparatuses include, but are not limited to, catalytic purification, metal hydride separation, pressure swing absorption, cryogenic distillation and/or membrane separation, including noble metal membrane separation, polymer membrane separation, or electrochemical membrane separation.

Although not illustrated in FIG. 3, in some embodiments, at least a portion of the r-syngas 160 can be introduced into a shift reactor to convert at least a portion of the carbon monoxide and water in the r-syngas 160 into carbon dioxide and hydrogen, thereby providing a hydrogen-enriched syngas (r-H2 syngas). In some cases, the r-H2 syngas can have a hydrogen to carbon monoxide ratio can be greater than 1.7:1, greater than 1.75:1, greater than 1.8:1, greater than 1.85:1, greater than 1.9:1, or greater than 1.95:1. Thereafter, the r-H2 syngas can be introduced into the separator 44b to form the streams of purified hydrogen 164 and syngas 162. Alternatively, or in addition, at least a portion of the purified r-H2 can be used in one or more other chemical processes to provide another recycled content product.

As shown in FIG. 3, the stream of purified r-H2 164 can be used as fuel to provide thermal energy to one or both of the pyrolysis reactor and the cracker furnace 32. In some embodiments, the stream 164 may be expanded in an expander 46 prior to being combined with one or both of the pyrolysis fuel 124a and the cracker fuel 124b. The stream of purified, expanded hydrogen 166 can comprise at least 50, at least 55, at least 60, at least 65, at least 70, at least 75, at least 80, at least 85, at least 90, at least 95, at least 97, or at least 99 mole percent hydrogen, including recycled content hydrogen (r-H2). Alternatively, or in addition, at least a portion of the purified r-H2 can be used in one or more other chemical processes to provide another recycled content product.

Additionally, as shown in FIG. 3, at least a portion of the recycled content pyrolysis gas (r-pygas) 114 from the separator 24 in the pyrolysis facility 20 can be passed through at least one hydrogen separator 44c to form a stream of purified hydrogen 132 and an r-pygas stream 130. Hydrogen separator 44c can be any suitable type of separator as described herein previously, and can provide a stream 132 comprising at least 75, at least 90, at least 95, or at least 99 percent hydrogen, including recycled content hydrogen (r-H2). In some embodiments, at least a portion of the hydrogen (r-H2) from the hydrogen separator 44c can be combined with at least one of pyrolysis fuel 124a and cracker fuel 124b, as shown in FIG. 3. Alternatively, or in addition, at least a portion of the purified r-H2 can be used in one or more other chemical processes to provide another recycled content product.

In one embodiment or in combination with one or more embodiments disclosed herein, the pyrolysis reaction performed in the pyrolysis reactor can be carried out at a temperature of less than 700, less than 650, or less than 600° C. and at least 300, at least 350, or at least 400° C. The feed to the pyrolysis reactor can comprise, consists essentially of, or consists of waste plastic. The feed stream, and/or the waste plastic component of the feed stream, can have a number average molecular weight (Mn) of at least 3000, at least 4000, at least 5000, or at least 6000 g/mole. If the feed to the pyrolysis reactor contains a mixture of components, the Mn of the pyrolysis feed is the weighted average Mn of all feed components, based on the mass of the individual feed components. The waste plastic in the feed to the pyrolysis reactor can include post-consumer waste plastic, post-industrial waste plastic, or combinations thereof. In certain embodiments, the feed to the pyrolysis reactor comprises less than 5, less than 2, less than 1, less than 0.5, or about 0.0 weight percent coal and/or biomass (e.g., lignocellulosic waste, switchgrass, fats and oils derived from animals, fats and oils derived from plants, etc.), based on the weight of solids in pyrolysis feed or based on the weight of the entire pyrolysis feed. The feed to the pyrolysis reaction can also comprise less than 5, less than 2, less than 1, or less than 0.5, or about 0.0 weight percent of a co-feed stream, including steam, sulfur-containing co-feed streams, and/or non-plastic hydrocarbons (e.g., non-plastic hydrocarbons having less than 50, less than 30, or less than 20 carbon atoms), based on the weight of the entire pyrolysis feed other than water or based on the weight of the entire pyrolysis feed.

Additionally, or alternatively, the pyrolysis reactor may comprise a film reactor, a screw extruder, a tubular reactor, a stirred tank reactor, a riser reactor, a fixed bed reactor, a fluidized bed reactor, a rotary kiln, a vacuum reactor, a microwave reactor, or an autoclave. The reactor may also utilize a feed gas and/or lift gas for facilitating the introduction of the feed into the pyrolysis reactor. The feed gas and/or lift gas can comprise nitrogen and can comprise less than 5, less than 2, less than 1, or less than 0.5, or about 0.0 weight percent of steam and/or sulfur-containing compounds.

In one embodiment or in combination with one or more embodiments disclosed herein, the cracker furnace can be operated at a product outlet temperature (e.g., coil outlet temperature) of at least 700, at least 750, at least 800, or at least 850° C. The feed to the cracker furnace can have a number average molecular weight (Mn) of less than 3000, less than 2000, less than 1000, or less than 500 g/mole. If the feed to the cracker furnace contains a mixture of components, the Mn of the cracker feed is the weighted average Mn of all feed components, based on the mass of the individual feed components. The feed to the cracker furnace can comprise less than 5, less than 2, less than 1, less than 0.5, or 0.0 weight percent of coal, biomass, and/or solids. In certain embodiments, a co-feed stream, such as steam or a sulfur-containing stream (for metal passivation) can be introduced into the cracker furnace. The cracker furnace can include both convection and radiant sections and can have a tubular reaction zone (e.g., coils in one or both of the convection and radiant sections). Typically, the residence time of the streams passing through the reaction zone (from the convection section inlet to the radiant section outlet) can be less than 20 seconds, less than 10 seconds, less than 5 seconds, or less than 2 seconds.

When a numerical sequence is indicated, it is to be understood that each number is modified the same as the first number or last number in the numerical sequence or in the sentence, e.g., each number is “at least,” or “up to” or “not more than” as the case may be; and each number is in an “or” relationship. For example, “at least 10, 20, 30, 40, 50, 75 wt. % . . . ” means the same as “at least 10 wt. %, or at least 20 wt. %, or at least 30 wt. %, or at least 40 wt. %, or at least 50 wt. %, or at least 75 wt. %,” etc.; and “not more than 90 wt. %, 85, 70, 60 . . . ” means the same as “not more than 90 wt. %, or not more than 85 wt. %, or not more than 70 wt. % . . . ” etc.; and “at least 1%, 2%, 3%, 4%, 5%, 6%, 7%, 8%, 9% or 10% by weight . . . ” means the same as “at least 1 wt. %, or at least 2 wt. %, or at least 3 wt. % . . . ” etc.; and “at least 5, 10, 15, 20 and/or not more than 99, 95, 90 weight percent” means the same as “at least 5 wt. %, or at least 10 wt. %, or at least 15 wt. % or at least 20 wt. % and/or not more than 99 wt. %, or not more than 95 wt. %, or not more than 90 weight percent . . . ” etc.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the phrase “at least a portion” includes at least a portion and up to and including the entire amount or time period.

As used herein, the term “chemical recycling” refers to a waste plastic recycling process that includes a step of chemically converting waste plastic polymers into lower molecular weight polymers, oligomers, monomers, and/or non-polymeric molecules (e.g., hydrogen, carbon monoxide, methane, ethane, propane, ethylene, and propylene) that are useful by themselves and/or are useful as feedstocks to another chemical production process(es).

As used herein, the term “co-located” refers to the characteristic of at least two objects being situated on a common physical site, and/or within one mile of each other.

As used herein, the term “commercial scale facility” refers to a facility having an average annual feed rate of at least 500 pounds per hour, averaged over one year.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the term “cracking” refers to breaking down complex organic molecules into simpler molecules by the breaking of carbon-carbon bonds.

As used herein, the terms “including,” “include,” and “included” have the same open-ended meaning as “comprising,” “comprises,” and “comprise” provided above.

As used herein, the term “located remotely” refers to a distance of greater than 1, greater than 5, greater than 10, greater than 50, greater than 100, greater than 500, greater than 1000, or greater than 10,000 miles between two facilities, sites, or reactors.

As used herein, the term “molecular reforming” refers to conversion of a carbon-containing feed into syngas (CO, CO2, and H2). Molecular reforming encompasses both steam reforming and partial oxidation (POX) gasification.

As used herein, the term “partial oxidation (POX) gasification” or “POX gasification” refers to high temperature conversion of a carbon-containing feed into syngas, (carbon monoxide, hydrogen, and carbon dioxide), where the conversion is carried out in the presence of a less than stoichiometric amount of oxygen.

As used herein, the term “predominantly” means more than 50 percent by weight. For example, a predominantly propane stream, composition, feedstock, or product is a stream, composition, feedstock, or product that contains more than 50 weight percent propane.

As used herein, the term “pyrolysis” refers to thermal decomposition of one or more organic materials at elevated temperatures in an inert (i.e., substantially oxygen free) atmosphere.

As used herein, the term “pyrolysis effluent” refers to the outlet stream withdrawn from the pyrolysis reactor in a pyrolysis facility.

As used herein, the terms “pyrolysis gas” and “pygas” refer to a composition obtained from pyrolysis that is gaseous at 25° C.

As used herein, the terms “pyrolysis oil” or “pyoil” refers to a composition obtained from pyrolysis that is liquid at 25° C. and 1 atm.

As used herein, the term “pyrolysis residue” refers to a composition obtained from pyrolysis that is not pyrolysis gas or pyrolysis oil and that comprises predominantly pyrolysis char and pyrolysis heavy waxes.

As used herein, the term “pyrolysis vapor” refers to the overhead or vapor-phase stream withdrawn from the separator in a pyrolysis facility used to remove r-pyrolysis residue from the r-pyrolysis effluent.

As used herein, the term “recycled content” refers to being or comprising a composition that is directly and/or indirectly derived from recycled material.

As used herein, the term “steam reforming” refers to the conversion of a carbon-containing feed into syngas via reaction with water. The steam reforming can be steam methane reforming and the carbon-containing feed can be a methane-containing stream, such as natural gas.

As used herein, the term “waste material” refers to used, scrap, and/or discarded material.

As used herein, the terms “waste plastic” and “plastic waste” refer to used, scrap, and/or discarded plastic materials.

### Additional Claim Supporting Description—First Embodiment

In a first embodiment of the present technology there is provided a chemical recycling process, said process comprising: (a) pyrolyzing a waste plastic feed in a pyrolysis facility to provide a recycled content pyrolysis effluent (r-pyrolysis effluent), wherein the pyrolyzing includes combusting a first fuel gas in a pyrolysis furnace; (b) cracking a hydrocarbon feed in a cracker furnace of a cracking facility to provide a cracker furnace effluent, wherein the cracking includes combusting a second fuel gas in the cracker furnace; and (c) separating a recycled content cracked stream (r-cracked stream) in a separation zone of the cracking facility to provide at least one recycled content product (r-product), wherein the r-cracked stream comprises at least a portion of the cracker furnace effluent, wherein at least one of the following criteria (i) through (vii) are met—(i) the first fuel gas has a hydrogen content of at least 10 mole percent; (ii) the second fuel gas has a hydrogen content greater than 40 mole percent; (iii) the first fuel gas comprises hydrogen originating from the cracking facility; (iv) at least one of the first and second fuel gas comprises hydrogen originating from the pyrolysis facility; (v) at least one of the first and second fuel gas comprises recycled content hydrogen (r-H2); (vi) wherein the hydrocarbon feed into the cracker furnace comprises at least a portion of the r-pyrolysis effluent and the first fuel gas comprises hydrogen and/or methane originating from the separation zone of the cracking facility; and (vii) wherein the r-cracked stream separated in step (c) comprises at least a portion of the r-pyrolysis effluent and the first fuel gas comprises hydrogen and/or methane originating from the separation zone of the cracking facility.

The first embodiment described in the preceding paragraph can also include one or more of the additional aspects/features listed in the following bullet pointed paragraphs. Each of the below additional features of the first embodiment can be standalone features or can be combined with one or more of the other additional features to the extent consistent. Additionally, the following bullet pointed paragraphs can be viewed as dependent claim features having levels of dependency indicated by the degree of indention in the bulleted list (i.e., a feature indented further than the feature(s) listed above it is considered dependent on the feature(s) listed above it).
wherein the pyrolysis furnace is a pyrolysis reactor.
wherein the pyrolysis furnace is a furnace used to warm a stream of heat transfer medium and wherein the warmed stream of heat transfer medium is used to provide thermal energy to a pyrolysis reactor.
further comprising, recovering a recycled content overhead stream (r-overhead stream) from the cracking facility and wherein at least one of the first and second fuel gases comprises at least a portion of the r-overhead stream.
   wherein the first fuel gas comprises at least a portion of the r-overhead stream.
   wherein the second fuel gas comprises at least a portion of the r-overhead stream.
   wherein both the first and second fuel gas comprise at least a portion of the r-overhead stream.
   wherein the r-overhead stream comprises an overhead stream withdrawn from a demethanizer.
      wherein the feed to the demethanizer column comprises a stream from a cold box.
      further comprising introducing at least a portion of the r-overhead stream from the demethanizer to a cold box and wherein the r-overhead stream withdrawn from the cracking facility comprises at least a portion of a stream withdrawn from the cold box.
   wherein the r-overhead stream comprises an overhead stream withdrawn from a cold box.
      wherein the cold box is upstream of a demethanizer.
         wherein the feed to the cold box comprises a compressed stream withdrawn from the last stage of an upstream compressor.
         further comprising a depropanizer located upstream of the last stage of the compressor, wherein at least a portion of the compressed stream withdrawn from the last stage of the upstream compressor comprises at least a portion of the depropanizer overhead stream.
      wherein the cold box is downstream of a deethanizer.
         wherein the feed to the cold box comprises at least a portion of a deethanizer overhead stream.
      wherein the r-overhead stream comprises recycled content methane (r-methane) and recycled content hydrogen (r-H2).
   wherein the r-overhead stream is withdrawn from a hydrogen separation unit.
      wherein the r-overhead stream predominantly comprises recycled content hydrogen (r-H2).
      wherein the r-overhead stream predominantly comprises recycled content methane (r-methane).
      wherein the feed to the hydrogen separation unit comprises a stream removed from a cold box.
      wherein the feed to the hydrogen separation unit comprises a compressed stream removed from an upstream compression zone in the cracking facility.
      wherein the hydrogen separation unit utilizes catalytic purification, metal hydride separation, pressure swing absorption, cryogenic distillation, and/or membrane separation.
         wherein the membrane separation comprises noble metal membrane separation, polymer membrane separation, or electrochemical membrane separation.
   wherein the r-overhead stream comprises at least 5, 10, 15, 20, 25, 30, 35, 40, 45, 50, 55, 60, 65, 70, 75, 80, 85, 90, or 95 mole percent hydrogen and/or not more than 95, 90, 85, 80, 75, 70, 65, 60, 55, 50, 45, 40, 35, 30, 25, 20, or 15 mole percent hydrogen.
   wherein the r-overhead stream comprises at least 5, 10, 15, 20, 25, 30, 35, 40, 45, 50, 55, 60, 65, 70, 75, 80, 85, 90, or 95 mole percent methane and/or not more than 95, 90, 85, 80, 75, 70, 65, 60, 55, 50, 45, 40, 35, 30, 25, 20, or 15 mole percent methane.
   wherein the combined amount of hydrogen and methane in the r-overhead stream is at least 25, 35, 50, 55, 65, 75, 85, or 90 weight percent and/or not more than 99, 95, 90, 85 weight percent.
   further comprising expanding at least a portion of the r-overhead stream to form an expanded stream and recovering at least a portion of the work generated from the expansion and using it in another portion of the pyrolysis and/or the cracking facility, and wherein at least one of the first and second fuel gas comprises the expanded stream.
      wherein the expanding is performed with an expansion valve.
      wherein the expansion is performed with a turboexpander.
wherein at least two (three, four, five, all) of (i) through (vi) are met.
wherein the cracking facility and the pyrolysis facility are co-located.
wherein the cracking facility is remotely located from the pyrolysis facility.
wherein at least a portion of the first and second fuel gas originates from the cracking facility.
wherein at least a portion of the first and/or second fuel gas originates from a molecular reforming facility.
further comprising, separating the r-pyrolysis effluent into a recycled content pyrolysis gas (r-pygas) and a recycled content pyrolysis oil (r-pyoil), and introducing at least a portion of the r-pygas and/or r-pyoil into the cracking facility.
   further comprising introducing at least a portion of the r-pyoil into the cracker furnace.
   further comprising, introducing at least a portion of the r-pygas into at least one of the quench, compression, and separation zones of the cracking facility.
   further comprising separating hydrogen from the r-pygas, wherein the first and/or second fuel gas comprises at least a portion of the separated hydrogen.
wherein the first fuel gas has a hydrogen content of at least 15, 20, 25, 30, 35, 40, 45, 50, 55, 60, 65, 70, 75, 80, 85, 90, or 95 mole percent.
wherein the first fuel gas comprises recycled content hydrogen (r-H2).
wherein the first fuel gas comprises hydrogen originating from the pyrolysis facility.
wherein the first fuel gas comprises hydrogen originating from the cracking facility.
wherein the first fuel gas includes less than 15, 10, 5, 2, 1, 0.5, 0.25, or 0.1 mole percent of components other than hydrogen.
wherein the first fuel gas comprises at least 20, 25, 30, 35, 40, 45, 50, 55, 60, 65, 70, 75, 80, 85, 90, 95, 97, 99, or 99.5 mole percent methane.
wherein the methane comprises recycled content methane (r-methane).
wherein the first fuel gas includes less than 15, 10, 5, 2, 1, 0.5, 0.25, or 0.1 mole percent of components other than r-methane.
wherein the first fuel gas comprises recycled content methane (r-methane) and recycled content hydrogen (r-H2).
   wherein at least one (both) of the r-methane and r-H2 originated from the cracking facility.
wherein the first fuel gas comprises non-recycled content.
wherein the first fuel gas has a high heating value (HHV) of at least 320, 350, 400, 450, 500 BTU/SCF and/or not more than 1000, 900, 800, 750 BTU/SCF.
further comprising forming a synthesis gas from a hydrocarbon feed in a molecular reforming facility and separating the synthesis gas to remove a purified hydrogen stream, wherein the first fuel gas comprises at least a portion of the purified hydrogen stream.
   wherein the molecular reforming includes partial oxidation.
   wherein the molecular reforming includes steam reforming.
   wherein the hydrocarbon feed comprises a recycled content hydrocarbon feed (r-HC feed) and the purified hydrogen stream comprises recycled content hydrogen (r-H2).
      wherein the r-HC feed is derived from waste plastic.
      wherein the r-HC feed comprises recycled content methane (r-methane) from the separation zone of the cracking facility.
   wherein the purified hydrogen stream comprises at least 50, 55, 60, 65, 70, 75, 80, 85, 90, 95, 97, or 99 mole percent hydrogen.
wherein the second fuel gas includes at least 15, 20, 25, 30, 35, 40, 45, 50, 55, 60, 65, 70, 75, 80, 85, 90, or 95 mole percent hydrogen.
wherein the second fuel gas comprises recycled content hydrogen.
wherein the second fuel gas comprises hydrogen originating from the pyrolysis facility.
wherein the second fuel gas comprises hydrogen originating from the cracking facility.
wherein the second fuel gas includes less than 15, 10, 5, 2, 1, 0.5, 0.25, or 0.1 mole percent of components other than hydrogen.
wherein the second fuel gas comprises at least 20, 25, 30, 35, 40, 45, 50, 55, 60, 65, 70, 75, 80, 85, 90, or 95 mole percent methane.
wherein the methane comprises recycled content methane (r-methane).
wherein the second fuel gas includes less than 15, 10, 5, 2, 1, 0.5, 0.25, or 0.1 mole percent of components other than r-methane.
wherein the second fuel gas comprises recycled content methane (r-methane) and recycled content hydrogen (r-H2).
   wherein at least one of the r-methane and r-H2 originated from the cracking facility.
   wherein both of the r-methane and the r-H2 originated from the cracking facility.
   wherein at least one of the r-methane and the r-H2 originated from the pyrolysis facility.
wherein the second fuel gas comprises non-recycled content.
wherein the second fuel gas has HHV of at least 320, 350, 400, 450, 500 BTU/SCF and/or not more than 1000, 900, 800, 750 BTU/SCF.
further comprising forming a synthesis gas from a hydrocarbon-containing feed in a molecular reformer and separating the synthesis gas to remove a purified hydrogen stream, wherein the second fuel gas comprises at least a portion of the purified hydrogen stream.
   wherein the hydrocarbon-containing feed comprises a recycled content hydrocarbon feed (r-HC feed) and the purified hydrogen stream comprises recycled content hydrogen (r-H2).
      wherein the r-HC feed is derived from waste plastic.
      wherein the r-HC feed comprises recycled content methane from the separation zone of the cracking facility.
   wherein the molecular reformer is a partial oxidation reformer.
   wherein the molecular reformer is a steam reformer.
   wherein the purified hydrogen stream comprises at least 50, 55, 60, 65, 70, 75, 80, 85, 90, 95, 97, or 99 mole percent hydrogen.
wherein the cracker furnace stack effluent has a total amount of CO and CO2 less than 8, 7, 6, 5, 4, 3, 2, 1, 0.5, 0.1 mole percent.
wherein the pyrolysis furnace stack effluent has a total amount of CO and CO2 less than 8, 7, 6, 5, 4, 3, 2, 1, 0.5, 0.1 mole percent.
wherein the first fuel gas has a total carbon content of less than 40, 35, 30, 25, 20, 15, 10, 5 mole %.
wherein the second fuel gas has a total carbon content of less than 40, 35, 30, 25, 20, 15, 10, 5 mole %.
further comprising, separating at least a portion of the r-pyrolysis effluent to form a recycled content pyrolysis residue (r-pyrolysis residue), a recycled content pyrolysis gas (r-pygas), and a recycled content r-pyrolysis oil (r-pyoil).
   further comprising introducing at least a portion of the r-pyoil into the cracker furnace of the cracking facility.
      wherein the r-pyoil is combined with the hydrocarbon feed introduced into the inlet of the cracker furnace.
   further comprising introducing at least a portion of the r-pygas into at least one zone of the cracking facility downstream of the cracker furnace.
      wherein the zone is a quench zone, a separation zone, or a compression zone of the cracking facility.
further comprising prior to the introducing, passing at least a portion of the r-pygas through a hydrogen separator and removing a stream of recycled content purified hydrogen (r-purified H2) from the separator, and wherein at least one of the first and second fuel gas streams comprises the r-purified H2.

### Additional Claim Supporting Description—Second Embodiment

In a second embodiment of the present technology there is provided a chemical recycling process, said process comprising: (a) compressing a cracker effluent to a pressure of at least 200 pounds per square inch gauge (psig), wherein the cracker effluent comprises a recycled content cracker effluent (r-cracker effluent); (b) separating at least a portion of the compressed r-cracker effluent in a separation zone to thereby produce recycled content methane (r-methane) and/or recycled content hydrogen (r-H2); and (c) combusting fuel to furnish thermal energy to a pyrolysis reactor and/or a cracking furnace in at least one process furnace in a pyrolysis and/or a cracking facility to heat at least one process stream, wherein the fuel comprises at least a portion of the r-methane and/or the r-H2.

The second embodiment described in the preceding paragraph can also include one or more of the additional aspects/features listed in the following bullet pointed paragraphs. Each of the below additional features of the second embodiment can be standalone features or can be combined with one or more of the other additional features to the extent consistent. Additionally, the following bullet pointed paragraphs can be viewed as dependent claim features having levels of dependency indicated by the degree of indention in the bulleted list (i.e., a feature indented further than the feature(s) listed above it is considered dependent on the feature(s) listed above it).
wherein the process furnace is the pyrolysis reactor.
wherein the process furnace is a furnace used to warm a stream of heat transfer medium and wherein the warmed stream of heat transfer medium is used to provide thermal energy to the pyrolysis reactor.
wherein the fuel comprises at least a portion of the r-methane.
wherein the fuel comprises at least a portion of the r-H2.
wherein the fuel comprises at least a portion of both the r-methane and the r-H2.
wherein the separating produces a predominantly r-methane stream.
   wherein at least a portion of the separating is performed in a demethanizer in the separation zone of the cracking facility.
   wherein at least a portion of the separating is performed in a cold box in the separation zone of the cracking facility.
   wherein at least a portion of the separating is performed in a hydrogen purification unit in the separation zone of a cracking facility.
      wherein the hydrogen purification unit is selected from the group consisting of a pressure swing absorber, a cryogenic distillation unit, or a membrane separator.
   further comprising introducing at least a portion of the r-methane into a molecular reforming unit to provide a recycled content syngas (r-syngas).
      further comprising, separating a recycled content predominantly hydrogen stream (r-H2) from the r-syngas, wherein the fuel combusted in the process furnace comprises at least a portion of the predominantly r-H2 stream.
wherein the separating produces a predominantly r-hydrogen stream.
   wherein at least a portion of the separating is performed in a cold box in the separation zone of the cracking facility.
   wherein at least a portion of the separating is performed in a hydrogen separation unit.
      wherein the hydrogen purification unit is selected from the group consisting of a pressure swing absorber, a cryogenic distillation unit, or a membrane separator.
      wherein the hydrogen separation unit is in the separation zone of the cracking facility.
wherein the separating produces both a predominantly r-hydrogen stream and a predominantly r-methane stream.
   wherein at least a portion of the separating is performed in a hydrogen separation unit in the separation zone of a cracking facility.
      wherein the feed to the hydrogen separation unit is a stream from a cold box.
      wherein the feed to the hydrogen separation unit is a portion of the compressed cracker effluent.
      further comprising introducing at least a portion of the r-methane into a molecular reformer to provide a recycled content syngas (r-syngas).
      wherein the hydrogen purification unit is selected from the group consisting of a pressure swing absorber, a cryogenic distillation unit, or a membrane separator.
wherein the separating produces a depressurized r-cracker effluent stream and further comprising separating at least a portion of the depressurized r-cracker effluent stream to provide another recycled content methane (r-methane) and/or another recycled content hydrogen (r-H2) and combusting at least a portion of the another r-methane and/or the another r-H2 in another process furnace.
   wherein the another process furnace is a cracker furnace in the cracking facility.
   wherein the another process furnace is a pyrolysis furnace in the pyrolysis facility.
   wherein the another process furnace is the same as the process furnace in the combusting of step (c).
   wherein the another process furnace is different than the process furnace in the combusting of step (c).
   wherein the first separation is performed in a cold box and the further separation is performed in a distillation column.
      wherein the distillation column is a demethanizer.
      further comprising prior to said cold box, separating a compressed cracker effluent in another column to provide an overhead lights stream and a bottom heavies stream and feeding at least a portion of the overhead lights stream to the cold box.
wherein the another column is a deethanizer.
wherein the another column is a depropanizer.
further comprising, compressing the overhead lights stream prior to introduction into the cold box.
   wherein the further separation is performed in a hydrogen separation unit.
wherein the combusting includes combusting fuel in a cracker furnace in a cracking facility.
wherein the combusting includes combusting fuel in a pyrolysis furnace in a pyrolysis facility.
further comprising expanding at least a portion of the r-methane and/or r-H2 to generate work and using at least a portion of the work in the pyrolysis and/or cracking facility, wherein the expanded r-methane and/or r-H2 is used in the combusting of step (c).
further comprising pyrolyzing waste plastic in a pyrolysis furnace of the pyrolysis facility to form a recycled content pyrolysis effluent (r-pyrolysis effluent) and introducing at least a portion of the r-pyrolysis effluent into the cracking facility to form at least one recycled content product (r-product).
   further comprising separating said r-pyrolysis effluent into a recycled content pyrolysis gas (r-pygas) and a recycled content pyrolysis oil (r-pyoil) and introducing at least one of the r-pygas and r-pyoil into the cracking facility.
      further comprising cracking at least a portion of the r-pyoil in a cracker furnace of the cracking facility.
      further comprising introducing at least a portion of the r-pygas at one or more locations downstream of a cracker furnace and separating at least a portion of the stream in a separation zone of the cracking facility.
      further comprising separating at least a portion of the r-pygas in a second separation zone to form recycled content hydrogen (r-H2), wherein the fuel combusted in step (c) comprises at least a portion of the r-H2.
wherein the combusting includes combusting fuel in a pyrolysis furnace, and wherein the fuel comprises at least a portion of the r-methane from the cracking facility.
wherein the combusting includes combusting fuel in a pyrolysis furnace, and wherein the fuel comprises at least a portion of the r-hydrogen from the cracking facility.
wherein the combusting includes combusting a fuel in a cracker furnace in the cracking facility and wherein the fuel comprises at least a portion of the r-methane from the cracking facility.
wherein the combusting includes combusting a fuel in a cracker furnace in the cracking facility and wherein the fuel comprises at least a portion of the r-hydrogen from the cracking facility.
wherein the combusting includes combusting a fuel in a cracker furnace in the cracking facility and/or combusting a fuel in a pyrolysis furnace in the pyrolysis facility, and wherein the fuel comprises at least a portion of the r-hydrogen from a molecular reforming facility.
wherein the combusting includes combusting a fuel in a cracker furnace in the cracking facility and/or combusting a fuel in a pyrolysis furnace in the pyrolysis facility, and wherein the fuel comprises at least a portion of the r-hydrogen from the pyrolysis facility.
wherein the cracker effluent has a pressure of at least 250, 300, 350, 400, or 450 psig and/or not more than 1000, 900, 800, 700, or 600 psig.
wherein the cracker effluent comprises recycled content methane (r-methane).
wherein the cracker effluent comprises recycled content hydrogen (r-H2).
wherein the amount of methane in the cracker effluent is at least 50, 75, 90, or 95 mole percent.
wherein the amount of hydrogen in the cracker effluent is at least 50, 75, 90, or 95 mole percent.
wherein the total amount of methane and hydrogen in the cracker effluent is at least 75, 80, 85, 90, 95, 97, or 99 mole percent of methane and hydrogen.
wherein the cracker furnace stack effluent has a total carbon content of less than 8, 7, 6, 5, 4, 3, 2, 1, 0.5, 0.1 mole percent (measured as total CO+CO2 content in the furnace stack effluent).
wherein the pyrolysis furnace stack effluent has a total carbon content of less than 8, 7, 6, 5, 4, 3, 2, 1, 0.5, 0.1 mole percent (measured as total CO+CO2 content in the furnace stack effluent).
wherein the first fuel gas has a total carbon content of less than 40, 35, 30, 25, 20, 15, 10, 5 mole %.
wherein the second fuel gas has a total carbon content of less than 40, 35, 30, 25, 20, 15, 10, 5 mole %.

### Additional Claim Supporting Description—Third Embodiment

In a third embodiment of the present technology there is provided a chemical recycling process, said process comprising: (a) separating recycled content syngas (r-syngas) in a separation zone to thereby produce recycled content hydrogen (r-H2); and (b) combusting fuel to furnish thermal energy to a pyrolysis reactor and/or a cracking furnace in at least one process furnace in a pyrolysis and/or a cracking facility to heat at least one process stream, wherein the fuel comprises recycled content from the r-H2.

The third embodiment described in the preceding paragraph can also include one or more of the additional aspects/features listed in the following bullet pointed paragraphs. Each of the below additional features of the third embodiment can be standalone features or can be combined with one or more of the other additional features to the extent consistent. Additionally, the following bullet pointed paragraphs can be viewed as dependent claim features having levels of dependency indicated by the degree of indention in the bulleted list (i.e., a feature indented further than the feature(s) listed above it is considered dependent on the feature(s) listed above it).
wherein the process furnace is the pyrolysis reactor.
wherein the process furnace is a furnace used to warm a stream of heat transfer medium and wherein the warmed stream of heat transfer medium is used to provide thermal energy to the pyrolysis reactor.
further comprising subjecting a recycled content hydrocarbon-containing feed (r-HC feed) to molecular reforming to provide the r-syngas.
   wherein the r-HC feed comprises methane.
      wherein the methane comprises recycled content.
      wherein the r-HC feed comprises an overhead stream withdrawn from a demethanizer column in the separation zone.
      herein the r-HC feed comprises a predominantly methane stream withdrawn from a hydrogen separator in the separation zone.
   wherein the molecular reforming comprises partial oxidation.
      wherein the r-HC feed is a solid, liquid, slurry, or gas phase feed.
      wherein the r-HC feed comprises non-recycled content.
      wherein the r-HC feed comprises coal.
      wherein the r-HC feed comprises waste plastic.
   wherein the molecular reforming comprises steam reforming.
      wherein the r-HC feed comprises a liquid or gas phase feed.
      wherein the r-HC feed comprises recycled content naphtha (r-naphtha).
         wherein at least a portion of the r-naphtha is obtained from the pyrolysis of waste plastic.
      wherein the r-HC feed comprises recycled content methane (r-methane).
         wherein at least a portion of the r-methane is obtained from the pyrolysis of waste plastic.
         wherein at least a portion of the r-methane originates from the separation zone of the cracking facility.
   further comprising reacting at least a portion of the r-syngas in a shift reactor to convert at least a portion of the carbon monoxide and water to carbon dioxide and hydrogen to generated a hydrogen-enriched syngas having recycled content (r-H2 syngas), wherein the r-H2 syngas is separated in the separating of step (a).
      herein the ratio of hydrogen to carbon monoxide in the r-H2 syngas is greater than 1.7:1, 1.75:1, 1.8:1, 1.85:1, 1.9:1, or 1.95:1.
wherein at least a portion of the separating is performed in a membrane separator.
wherein the combusting includes combusting fuel in a cracker furnace in a cracking facility.
further comprising expanding at least a portion of the r-H2 to generate work and using at least a portion of the work in the pyrolysis and/or cracking facility, wherein the expanded r-H2 is used in the combusting of step (c).
further comprising pyrolyzing waste plastic in a pyrolysis furnace of the pyrolysis facility to form a recycled content pyrolysis effluent (r-pyrolysis effluent) and introducing at least a portion of the r-pyrolysis effluent into the cracking facility to form at least one recycled content product (r-product).
   further comprising separating at least a portion of said r-pyrolysis effluent into a recycled content pyrolysis gas (r-pygas) and a recycled content pyrolysis oil (r-pyoil) and introducing at least one of the r-pygas and r-pyoil into the cracking facility.
      further comprising cracking at least a portion of the r-pyoil in a cracker furnace of the cracking facility.
      further comprising introducing at least a portion of the r-pygas at one or more locations downstream of a cracker furnace and separating at least a portion of the stream in a separation zone of the cracking facility.
wherein the amount of hydrogen in the r-syngas gas is at least 50, 75, 90, or 95 mole percent.

### Additional Claim Supporting Description—Fourth Embodiment

In a fourth embodiment of the present technology there is provided a chemical recycling process, said process comprising: (a) pyrolyzing a stream comprising waste plastic to provide a recycled content pyrolysis effluent (r-pyrolysis effluent); (b) introducing at least a portion of the r-pyrolysis effluent into a cracking facility; (c) recovering a recycled content overhead stream (r-overhead stream) from the cracking facility; (d) optionally subjecting a hydrocarbon feed to a molecular reformer to provide a synthesis gas; and (e) using at least a portion of the r-overhead stream and/or syngas as a fuel to provide thermal energy for the pyrolyzing of step (a).

The fourth embodiment described in the preceding paragraph can also include one or more of the additional aspects/features listed in the following bullet pointed paragraphs. Each of the below additional features of the fourth embodiment can be standalone features or can be combined with one or more of the other additional features to the extent consistent. Additionally, the following bullet pointed paragraphs can be viewed as dependent claim features having levels of dependency indicated by the degree of indention in the bulleted list (i.e., a feature indented further than the feature(s) listed above it is considered dependent on the feature(s) listed above it).
further comprising cracking a hydrocarbon-containing feed stream in a cracker furnace to provide a cracked effluent and separating the cracked effluent into one or more recycled content products (r-products) in a separation zone of the cracking facility, wherein the r-overhead stream recovered in step (c) is recovered from the separation zone.
   further comprising using at least a portion of the r-overhead stream and/or syngas as fuel to provide heat for the cracking.
further comprising subjecting a hydrocarbon feed to molecular reforming to provide a synthesis gas and using at least a portion of the syngas as fuel to provide heat for the pyrolyzing of step (a).
   wherein the molecular reforming comprises partial oxidation reforming.
   wherein the molecular reforming comprises steam reforming.
   wherein the hydrocarbon feed comprises recycled content and the synthesis gas is a recycled content synthesis gas (r-syngas).
   wherein the hydrocarbon feed comprises recycled content methane (r-methane).
   further comprising separating a stream of purified hydrogen out of the synthesis gas and using at least a portion of the purified hydrogen as fuel to provide heat to the pyrolyzing of step (a).
      wherein the purified hydrogen comprises at least 75, 90, 95, or 99 mole percent hydrogen.
      wherein the hydrogen comprises recycled content hydrogen (r-H2).
      further comprising subsequent to step (a), separating at least a portion of the r-pyrolysis effluent into at least a recycled content pyrolysis gas (r-pygas) and a recycled content pyrolysis oil (r-pyoil) and introducing at least a portion of the r-pygas and/or r-pyoil into the cracking facility.
   wherein at least a portion of the r-pygas is introduced into the cracking facility in at least one location downstream of a cracker furnace.
   wherein at least a portion of the r-pyoil is introduced into a cracker furnace of the cracking facility.
wherein the r-overhead stream from the cracking facility comprises at least 50, 75, 90, or 95 mole percent hydrogen.
wherein the r-overhead stream from the cracking facility comprises at least 60, 57, 90, or 95 mole percent methane.
wherein the r-overhead stream from the cracking facility comprises less than 10, 5, 2, 1, 0.5 mole percent of components other than hydrogen and/or methane.
wherein the r-overhead stream from the cracking facility comprises recycled content hydrogen (r-H2).
wherein the r-overhead stream from the cracking facility comprises recycled content methane (r-methane).
wherein the r-overhead stream from the cracking facility is a demethanizer overhead stream.
wherein the r-overhead stream from the cracking facility is a demethanizer cold box off gas stream.
wherein the r-overhead stream from the cracking facility is a predominantly hydrogen stream from a hydrogen purification unit.
wherein the r-overhead stream from the cracking facility is a predominantly methane stream from a hydrogen purification unit.
wherein the cracking facility and the pyrolysis facility are co-located.
wherein the cracking facility is remotely located from the pyrolysis facility.

### CLAIMS NOT LIMITED TO DISCLOSED EMBODIMENTS

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A chemical recycling process, said process comprising:
(a) pyrolyzing a waste plastic feed in a pyrolysis facility to provide a recycled content pyrolysis effluent (r-pyrolysis effluent), wherein the pyrolyzing includes combusting a first fuel gas in a pyrolysis furnace;
(b) cracking a hydrocarbon feed in a cracker furnace of a cracking facility to provide a cracker furnace effluent, wherein the cracking includes combusting a second fuel gas in the cracker furnace; and
(c) separating a recycled content cracked stream (r-cracked stream) in a separation zone of the cracking facility to provide at least one recycled content product (r-product), wherein the r-cracked stream comprises at least a portion of the cracker furnace effluent,
wherein at least one of the following criteria (i) through (vii) are met—
(i) the first fuel gas has a hydrogen content of at least 10 mole percent;
(ii) the second fuel gas has a hydrogen content greater than 40 mole percent;
(iii) the first fuel gas comprises hydrogen originating from the cracking facility;
(iv) at least one of the first and second fuel gas comprises hydrogen originating from the pyrolysis facility;
(v) at least one of the first and second fuel gas comprises recycled content hydrogen (r-H2);
(vi) wherein the hydrocarbon feed into the cracker furnace comprises at least a portion of the r-pyrolysis effluent and the first fuel gas comprises hydrogen and/or methane originating from the separation zone of the cracking facility; and
(vii) wherein the r-cracked stream separated in step (c) comprises at least a portion of the r-pyrolysis effluent and the first fuel gas comprises hydrogen and/or methane originating from the separation zone of the cracking facility.

2. The process of claim 1, further comprising, recovering an overhead stream from the cracking facility and wherein at least one of the first and second fuel gases comprises at least a portion of the overhead stream.

3. The process of claim 2, wherein the overhead stream comprises an overhead stream withdrawn from a demethanizer or a from an overhead stream withdrawn from a cold box.

4. The process of claim 2, wherein the overhead stream is withdrawn from a hydrogen separation unit, wherein the hydrogen separation unit utilizes catalytic purification, metal hydride separation, pressure swing absorption, cryogenic separation or distillation, and/or membrane separation.

5. The process of claim 2, wherein the overhead stream comprises at least 50 mole percent hydrogen and/or not more than 95 mole percent methane.

6. The process of claim 2, further comprising expanding at least a portion of the overhead stream to form an expanded stream and recovering at least a portion of the work generated from the expansion and using it in another portion of the pyrolysis and/or the cracking facility, and wherein at least one of the first and second fuel gas comprises the expanded stream.

7. The process of claim 1, wherein at least one of the following criteria (i) through (xi) are met—
(i) wherein the first fuel gas has a hydrogen content of at least 15 mole percent;
(ii) wherein the first fuel gas comprises recycled content hydrogen (r-H2);
(iv) wherein the first fuel gas comprises hydrogen originating from the pyrolysis facility;
(v) wherein the first fuel gas comprises hydrogen originating from the cracking facility;
(vi) wherein the first fuel gas includes less than 15 mole percent of components other than hydrogen;
(vii) wherein the first fuel gas comprises at least 20 mole percent methane;
(viii) wherein the methane comprises recycled content methane (r-methane);
(ix) wherein the first fuel gas includes less than 15 mole percent of components other than r-methane;
(ix) wherein the first fuel gas comprises recycled content methane (r-methane) and recycled content hydrogen (r-H2);
(x) wherein the first fuel gas comprises non-recycled content; and
(xi) wherein the first fuel gas has a high heating value (HHV) of at least 320 BTU/SCF and/or not more than 1000 BTU/SCF.

8. The process of claim 1, wherein at least one of the following criteria (i) through (xi) are met—
(i) wherein the second fuel gas has a hydrogen content of at least 15 mole percent;
(ii) wherein the second fuel gas comprises recycled content hydrogen (r-H2);
(iii) wherein the second fuel gas comprises hydrogen originating from the pyrolysis facility;
(iv) wherein the second fuel gas comprises hydrogen originating from the cracking facility;
(v) wherein the second fuel gas includes less than 15 mole percent of components other than hydrogen;
(vi) wherein the second fuel gas comprises at least 20 mole percent methane;
(vii) wherein the methane comprises recycled content methane (r-methane);
(viii) wherein the second fuel gas includes less than 15 mole percent of components other than r-methane;
(ix) wherein the second fuel gas comprises recycled content methane (r-methane) and recycled content hydrogen (r-H2);
(x) wherein the second fuel gas comprises non-recycled content; and
(xi) wherein the second fuel gas has a high heating value (HHV) of at least 320 BTU/SCF and/or not more than 1000 BTU/SCF.

9. The process of claim 1, further comprising forming a synthesis gas from a hydrocarbon feed in a molecular reforming facility and separating the synthesis gas to remove a purified hydrogen stream, wherein the first fuel gas and/or the second fuel gas comprises at least a portion of the purified hydrogen stream.

10. The process of claim 1, wherein the cracker furnace stack effluent and/or the pyrolysis furnace stack effluent has a total amount of CO and CO2 less than 8 mole percent.

11. A chemical recycling process, said process comprising:
(a) compressing a cracker effluent to a pressure of at least 200 pounds per square inch gauge (psig), wherein the cracker effluent comprises a recycled content cracker effluent (r-cracker effluent);
(b) separating at least a portion of the compressed r-cracker effluent in a separation zone to thereby produce recycled content methane (r-methane) and/or recycled content hydrogen (r-H2); and
(c) combusting fuel to furnish thermal energy to a pyrolysis reactor and/or a cracking furnace in at least one process furnace in a pyrolysis and/or a cracking facility to heat at least one process stream, wherein the fuel comprises at least a portion of the r-methane and/or the r-H2.

12. The process of claim 11, wherein the fuel comprises at least a portion of both the r-methane and the r-H2.

13. The process of claim 11, wherein the separating produces
a predominantly r-methane stream, wherein the fuel combusted in step (c) comprises at least a portion of the r-methane, and wherein at least a portion of the separating is performed in a demethanizer in one or more of a demethanizer in the separation zone of the cracking facility, in a cold box in the separation zone of the cracking facility, and in a hydrogen purification unit in the separation zone of a cracking facility, or
a predominantly r-hydrogen stream, wherein the fuel combusted in step (c) comprises at least a portion of the r-hydrogen stream, and wherein at least a portion of the separating is performed in a cold box in the separation zone of the cracking facility and/or in a hydrogen purification unit in the separation zone of a cracking facility.

14. The process of claim 11, wherein the separating produces a depressurized r-cracker effluent stream and further comprising separating at least a portion of the depressurized r-cracker effluent stream to provide another recycled content methane (r-methane) and/or another recycled content hydrogen (r-H2) and combusting at least a portion of the another r-methane and/or the another r-H2 in another process furnace.

15. The process of claim 11, further comprising pyrolyzing waste plastic in a pyrolysis furnace of the pyrolysis facility to form a recycled content pyrolysis effluent (r-pyrolysis effluent) and introducing at least a portion of the r-pyrolysis effluent into the cracking facility to form at least one recycled content product (r-product), further comprising separating said r-pyrolysis effluent into a recycled content pyrolysis gas (r-pygas) and a recycled content pyrolysis oil (r-pyoil) and introducing at least one of the r-pygas and r-pyoil into the cracking facility, wherein the introducing includes introducing at least a portion of the r-pyoil into a cracker furnace of the cracking facility and/or introducing at least a portion of the r-pygas at one or more locations downstream of the cracker furnace and separating at least a portion of the stream in a separation zone of the cracking facility.

16. A chemical recycling process, said process comprising:
(a) separating recycled content syngas (r-syngas) in a separation zone to thereby produce recycled content hydrogen (r-H2); and
(b) combusting fuel to furnish thermal energy to a pyrolysis reactor and/or a cracking furnace in at least one process furnace in a pyrolysis and/or a cracking facility to heat at least one process stream, wherein the fuel comprises recycled content from the r-H2.

17. The process of claim 16, further comprising subjecting a recycled content hydrocarbon-containing feed (r-HC feed) to molecular reforming to provide the r-syngas, wherein the r-HC feed comprises methane, wherein the methane comprises recycled content methane.

18. A chemical recycling process, said process comprising:
(a) pyrolyzing a stream comprising waste plastic to provide a recycled content pyrolysis effluent (r-pyrolysis effluent);
(b) introducing at least a portion of the r-pyrolysis effluent into a cracking facility;
(c) recovering an overhead stream from the cracking facility;
(d) optionally subjecting a hydrocarbon feed to a molecular reformer to provide a synthesis gas; and
(e) using at least a portion of the overhead stream and/or syngas as a fuel to provide heat for the pyrolyzing of step (a).

19. The process of claim 18, further comprising cracking a hydrocarbon-containing feed stream in a cracker furnace to provide a cracked effluent and separating the cracked effluent into one or more recycled content products (r-products) in a separation zone of the cracking facility, wherein the overhead stream recovered in step (c) is recovered from the separation zone.

20. The process of claim 18, further comprising subjecting a hydrocarbon feed to molecular reforming to provide a synthesis gas and using at least a portion of the syngas as fuel to provide heat for the pyrolyzing of step (a).
